(19) United States
(12) Patent Application Publication
(10) Pub. No.: US 2012/0033931 A1
(43) Pub. Date: Feb. 9, 2012

(54) Waveguide

(76) Inventors: Hideyuki Usui, Kanagawa (JP); Takaki Naito, Kanagawa (JP)

(21) Appl. No.: 13/271,793

(22) Filed: Oct. 12, 2011

Related U.S. Application Data
(63) Continuation of application No. PCT/JP2010/055905, filed on Mar. 31, 2010.

(30) Foreign Application Priority Data
Apr. 16, 2009 (JP) 2009-099970

(51) Int. Cl. G02B 6/00

(52) U.S. Cl. 385/141

(57) ABSTRACT

A waveguide having a main body, an inner housing, and a wave receiving transmission path. The main body includes a body resin member, a concave groove extending in a longitudinal direction and a body metal plating layer over an entire surface of the concave groove. The inner housing has a resin cover member and an inner housing metal plating layer along an inner wall of the inner housing. The wave receiving transmission path is formed when the inner housing covers the concave groove of the main body when the main body and cover are assembled together.

### CROSS-REFERENCE TO RELATED APPLICATION

This application is a continuation of PCT International Application No. PCT/JP2010/055905 filed Mar. 31, 2010, which claims priority under 35 U.S.C. §119 to Japanese Patent Application No. 2009-099970, filed Apr. 16, 2009.

### FIELD OF INVENTION

The present invention relates to a waveguide and in particular to a resin waveguide having a metal plating layer.

### BACKGROUND

Generally, there are known resin waveguides made of a metal tube and known resin waveguides formed by plating an internal surface of a tube made of resin with metal used for transmitting radio waves such as microwaves and millimeter waves,

The transmission of radio waves by waveguides has advantages in that transmission loss is less than in the transmission of radio waves through a wire such as a shielding wire. Additionally, a transmission loss does not increase depending on a transmission distance, and moreover, there is no influence by external electrical noise.

Also, a resin waveguide having a polycarbonate resin as a covering layer, an ABS resin as an adherent layer (internal layer), and a metal plating on an inner surface of the adherent layer (internal layer) has been disclosed.

Although metal waveguides may be prepared in various way, for example, by bending, weight reduction of a device in which the waveguide is incorporated is hindered because it is made of metal, and a short circuit due to contact with other electrical components is likely to occur.

In contrast, the known resin waveguide contributes to weight reduction of a device in which the waveguide is incorporated, and a short circuit due to contact with other electrical components is unlikely to occur.

However, the known resin waveguide is generally formed using a molding die, by pulling the molding die along a longitudinal direction. As a result, the shape of the resin waveguide is limited to a linear shape that can be pulled from the molding die. Therefore, a waveguide that needs to have a U-shaped transmission path as a whole such as a waveguide in which both a transmitting section and a receiving section face in a same direction may not be formed by the known technique.

In a millimeter-wave waveguide used when transmitting millimeter waves, the diameter of a transmission path needs to be small. In a case where the known technique is applied to the millimeter-wave waveguide of such a small diameter, a problem may occur, wherein clogging of the transmission path due to plating accumulation occurs when an inner surface of a resin tube (namely, an inner wall of the transmission path) is subjected to metal plating.

Also, as for the known resin waveguide, in a plating process in which the inner surface of the tube made of resin is subjected to the metal plating, the greater the length of the waveguide in the longitudinal direction is, the higher the probability of uneven plating occur. Additionally, it is difficult to form an even metal plating layer in the waveguide made of resin that is long in the longitudinal direction.

Further, in the known resin waveguide process, the metal plating layer is formed along the inner surface of the known resin waveguide and thus, the metal plating layer may not be visually checked. Therefore, even when, for example, a defect such as a so-called “plating missing” in which plating does not adhere to a resin in a plating process occurs, this defect may be overlooked.

### SUMMARY

In view of the foregoing circumstances, it is an object of the invention, among other objects, to provide a waveguide made of resin in which an even metal plating layer may be formed irrespective of the length in a longitudinal direction and the diameter of a transmission path, such that the formed metal plating layer may be easily inspected.

A waveguide according to the invention has a main body, an inner housing, and a wave receiving transmission path. The main body includes a body resin member, a concave groove extending in a longitudinal direction and a body metal plating layer over an entire surface of the concave groove. The inner housing has a resin cover member and an inner housing metal plating layer along an inner wall of the inner housing. The wave receiving transmission path is formed when the inner housing covers the concave groove of the main body when the main body and cover are assembled together.

According to the present invention, there is provided a waveguide made of resin which may support various shapes, in which an even metal plating layer may be formed irrespective of the length in a longitudinal length and the diameter of a transmission path, and in which the formed metal plating layer is readily checked.

### BRIEF DESCRIPTION OF THE DRAWINGS

The above and other features of the present invention will become more apparent by describing in detail embodiments thereof with reference to the accompanying drawings, in which:

FIG. 1 is a front perspective view of a waveguide according to the invention with a millimeter-wave module;

FIG. 2 is a front perspective view of the waveguide and the millimeter-wave module shown in FIG. 1 before they are combined with each other;

FIG. 3 is an exploded perspective view of the waveguide with a main body and an inner housing are separated from each other;

FIG. 4 is a longitudinal sectional diagram taken along lines 4-4 shown in FIG. 3;

FIG. 5a is a plan view of the main body shown in FIG. 3;

FIG. 5b is a front view of the main body shown in FIG. 3;

FIG. 5c is a left side view of the main body shown in FIG. 3;

FIG. 5d is a right side view of the main body shown in FIG. 3;

FIG. 5e is a bottom view of the main body shown in FIG. 3;

FIG. 6a is a plan view of the inner housing shown in FIG. 3;

FIG. 6b is a front view of the inner housing shown in FIG. 3;

FIG. 6c is a left side view of the inner housing shown in FIG. 3;

FIG. 6d is a right side view of the inner housing shown in FIG. 3;

FIG. 6e is a bottom view of the inner housing shown in FIG. 3;

FIG. 7 is an exploded perspective view of another embodiment of a waveguide according to the invention, with a main body and an inner housing are separated from each other;

FIG. 8 is a longitudinal sectional diagram taken along a line 8-8 shown in FIG. 7;

FIG. 9 is a longitudinal sectional diagram taken along a line 9-9 shown in FIG. 7;

FIG. 10a is a plan view of the main body shown in FIG. 7;

FIG. 10b is a front view of the main body shown in FIG. 7;

FIG. 10c is a left side view of the main body shown in FIG. 7;

FIG. 10d is a right side view of the main body shown in FIG. 7;

FIG. 10e is a bottom view of the main body shown in FIG. 7;

FIG. 11a is a plan view of the inner housing shown in FIG. 7;

FIG. 11b is a front view of the inner housing shown in FIG. 7;

FIG. 11c is a left side view of the inner housing shown in FIG. 7;

FIG. 11d is a right side view of the inner housing shown in FIG. 7; and

FIG. 11e is a bottom view of the inner housing shown in FIG. 7.

### DETAILED DESCRIPTION OF THE EMBODIMENTS

Embodiments of the present invention will be described with reference to the drawings.

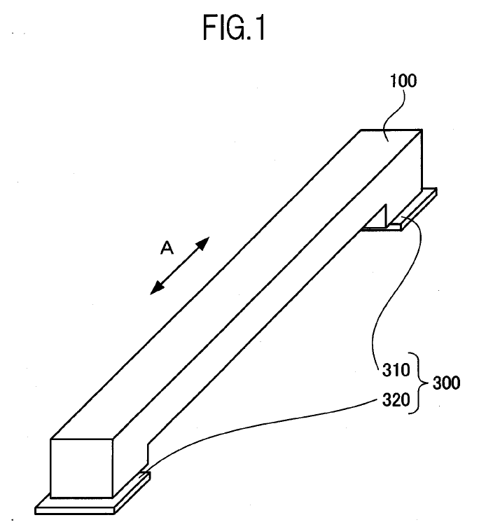

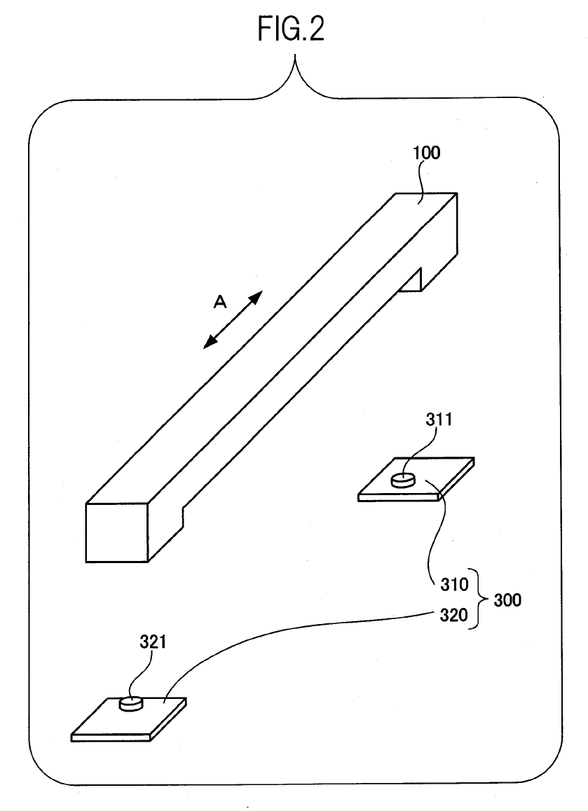

FIG. 1 shows a waveguide 100 according to the invention combined with a millimeter-wave module 300, as viewed obliquely from above, while FIG. 2 shows the waveguide 100 and the millimeter-wave module 300 before they are combined with each other. The millimeter-wave module 300 is, for example, provided in a display panel of a liquid crystal display television (not illustrated). The millimeter-wave module 300 includes a transmitting-side module 310 having a millimeter-wave antenna 311, and a receiving-side module 320 having a millimeter-wave antenna 321. And, the waveguide 100 is a waveguide for millimeter waves which is used for millimeter wave communication of 60 GHz, and links the millimeter-wave antenna 311 of the transmitting-side module 310 and the millimeter-wave antenna 321 of the receiving-side module 320. Also, this waveguide 100 extends in an arrow-A direction which is a longitudinal direction, and has a cross section shaped like a rectangle.

It is to be noted that the display panel of the liquid crystal display television which is an object to be provided with the millimeter-wave module 300 is merely an example, and the object may be, for example, a personal computer, a gaming machine, a video recorder, a digital camera, an access point, or the like.

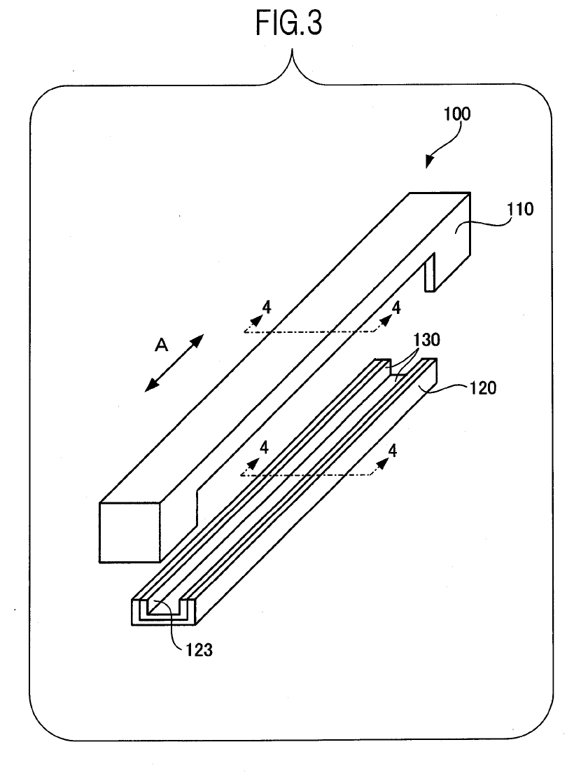

As illustrated in FIG. 3, the waveguide 100 is a hollow waveguide made of resin, and includes a main body 110 and an inner housing 120, and has a metal plating layer 130 on an inner surface of a tube made of resin (namely, an inner wall of a transmission path).

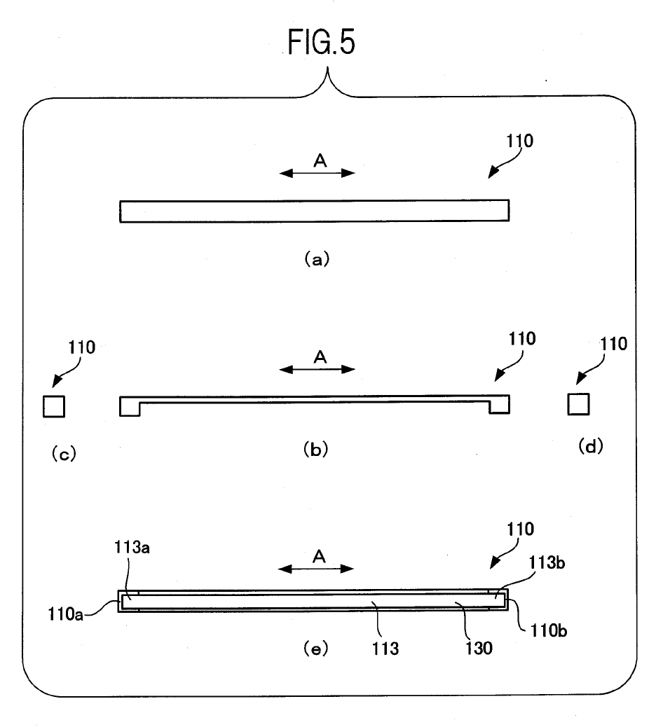

The main body 110 shown in FIG. 3 to FIG. 5 is formed by two shot molding of an ABS resin to form an internal layer 111 by adhering to the metal plating layer 130, and a polycarbonate resin to form an external layer 112 by adhering to the ABS resin without adhering to the metal plating layer 130. The ABS resin is an example of the first resin according to the invention, and the polycarbonate resin is an example of the second resin according to the present invention. Further, a concave groove 113 is formed in the main body 110, in an inner part, excluding both end portions 110a and 110b of the main body 110 in the arrow-A direction and inside these both end portions 110a and 110b, and extending in the arrow-A direction. Furthermore, the main body 110 has the metal plating layer 130 over the entire surface of the concave groove 113.

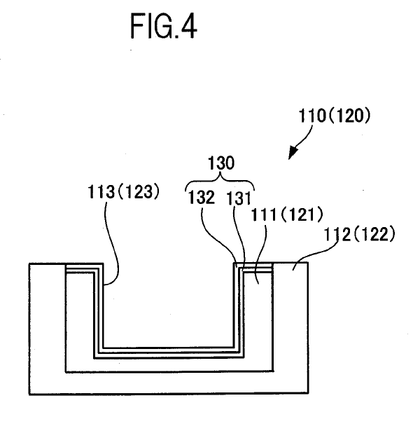

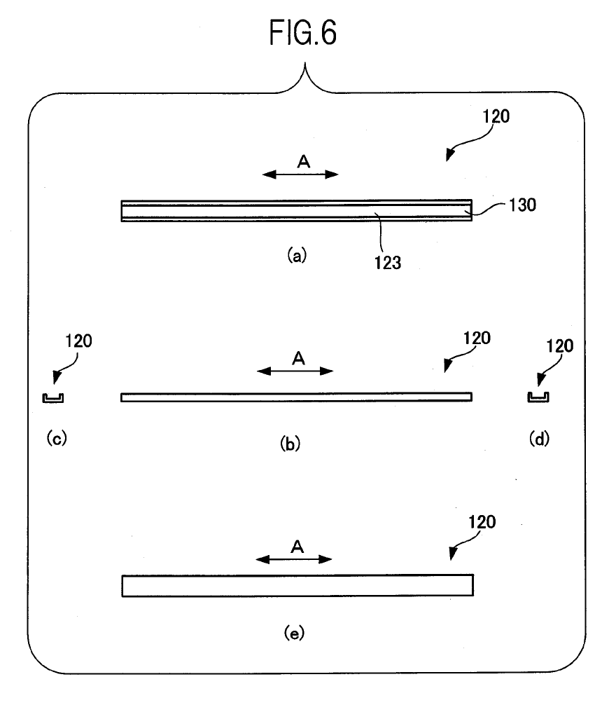

Similarly to the main body 110, the inner housing 120 shown in FIG. 3, FIG. 4 and FIG. 6 is formed by two shot molding of an ABS resin to form an internal layer 121 that adheres to the metal plating layer 130, and a polycarbonate resin to form an external layer 122 that adheres to the ABS resin without adhering to the metal plating layer 130. The ABS resin is an example of the first resin according to the invention, and the polycarbonate resin is an example of the second resin according to the invention. Further, the inner housing 120 covers the concave groove 113 of the main body 110 excluding both end portions 113a and 113b in the arrow-A direction, this section being inner than the both end portions 113a and 113b of the concave groove 113 of the main body 110. A concave groove 123 is formed in the inner housing 120 and has a width equal to a width of the concave groove 113 of the main body 110 and extending in the arrow-A direction. Furthermore, the inner housing 120 has the metal plating layer 130 along a section of an inner wall that defines a wave receiving transmission path (a transmission path) formed by covering the concave groove 113 of the main body 110 with the inner housing 120 and bonding them, namely, over the entire surface of the concave groove 123 of the inner housing 120.

As shown in FIG. 4, the metal plating layer 130 has a two-layer structure that protects against corrosion. Specifically, this metal plating layer 130 has: a copper plating layer 131 that adheres to the ABS resin forming each of the internal layers 111 and 121 of the main body 110 and the inner housing 120, and a nickel plating layer 132 that adheres to and laminated on the copper plating layer 131. Further, the surface of the ABS resin that adheres to the metal plating layer 130 and forming the internal layers 111 and 121 is roughened in order to increase a degree of adherence to the plating.

What is formed by covering the concave groove 113 of the main body 110 with the inner housing 120 and bonding them is the waveguide 100, and the wave receiving transmission path formed by this becomes the transmission path. Further, the concave groove 113 of the main body 110 is formed inside the both end portions 110a and 110b of the main body 110. The inner housing 120 covers the inner part of both end portions 113a and 113b of the concave groove 113, and thereby, the waveguide 100 has the transmission path shaped like a letter U as a whole in the embodiment shown. The cross section of the transmission path has a rectangular shape in the embodiment shown, and the waveguide 100 is a waveguide for millimeter waves used for millimeter wave communication of 60 GHz and therefore, the section size of this transmission path is, for example, “0.4 mm×0.4 mm.” It is to be noted that the section size of the transmission path may be larger than or smaller than “0.4 mm×0.4 mm.”

In this way, the waveguide 100 of the shown embodiment includes the main body 110 and the inner housing 120, and the transmission path is the wave receiving transmission path formed by the respective concave grooves 113 and 123 of the main body 110 and the inner housing 120. Therefore, when the metal plating layer 130 is formed on each of the main body 110 and the inner housing 120. As a result, the main body 110 and the inner housing 120 may be separated from each other, such that an area where the metal plating layer 130 is to be formed is exposed. Thus, according to the waveguide 100 of the shown embodiment, even if the section size of the transmission path in which the cross section has the rectangular shape is “0.4 mm×0.4 mm” which is extremely small, it is possible to avoid a problem of clogging the transmission path due to plating accumulation. Further, according to the waveguide 100 of the shown embodiment, it is possible to avoid a problem uneven plating. Moreover, according to the waveguide 100 of the sown embodiment, visual inspection of the metal plating layer 130 is easy and thus, a defect in the metal plating layer such as “plating missing” may be removed. As a result, the surface of the metal plating layer 130 may be made even.

This concludes the description of one embodiment of the invention, and another embodiment of the invention will be described.

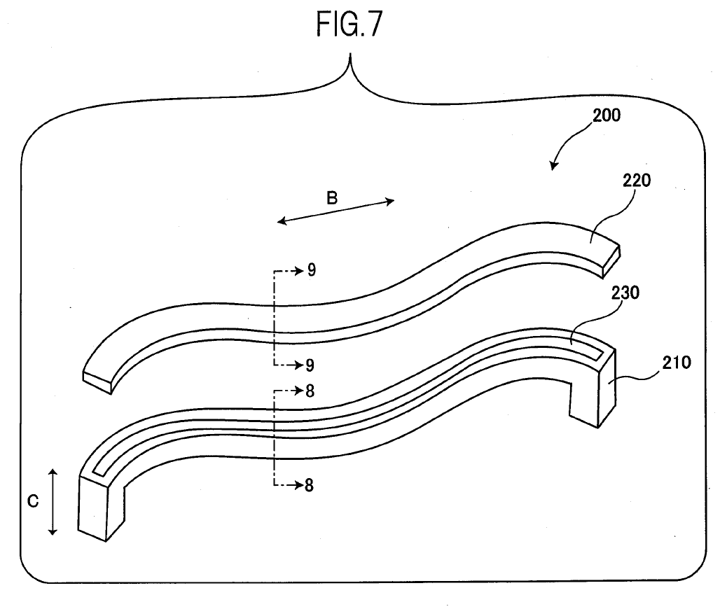

As shown in FIG. 7, a waveguide 200 according to another embodiment of the invention is a hollow waveguide made of resin and is configured of the main body 210 and the inner housing 220, and has a metal plating layer 230 on an inner surface of a tube made of resin (namely, an inner wall of a transmission path). Further, the waveguide 200 extends in an arrow-B direction which is a longitudinal direction while curving, and has a rectangular cross section. Furthermore, like the waveguide 100, waveguide 200 is a waveguide for millimeter waves used for millimeter wave communication of 60 GHz.

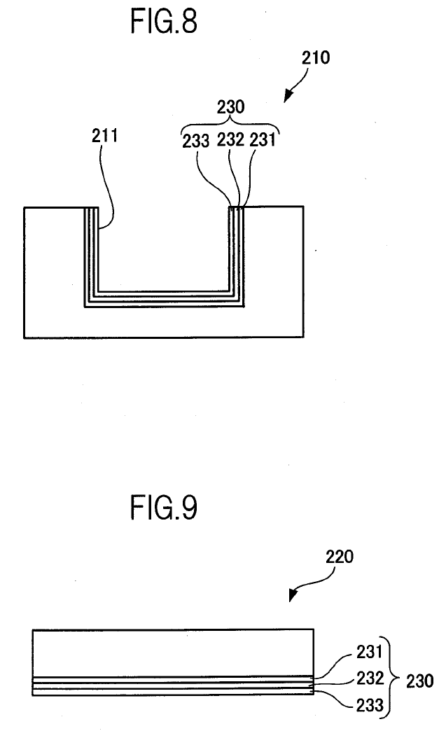

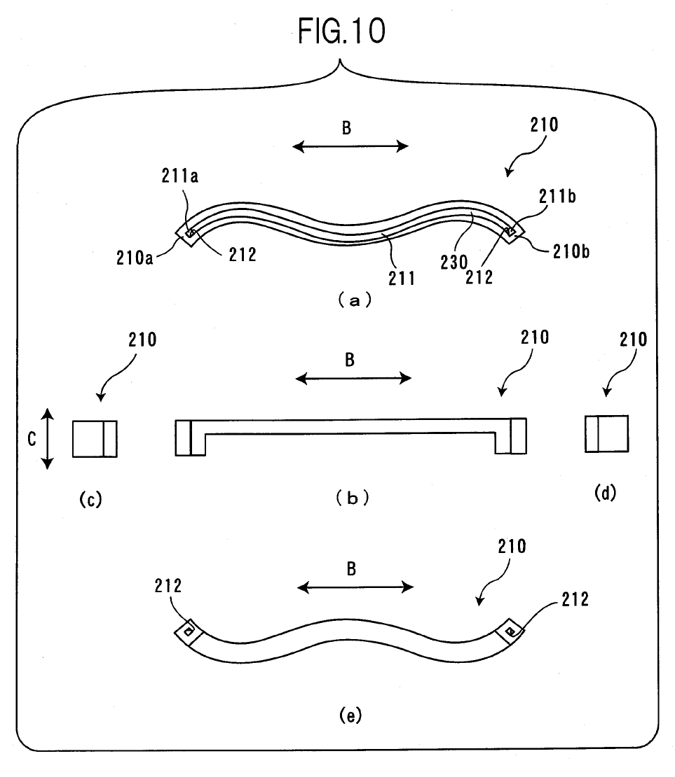

The main body 210 shown in FIG. 7, FIG. 8 and FIG. 10 is formed by molding of an ABS resin. The ABS resin is an example of the resin member according to the invention. Further, a concave groove 211 is formed in the main body 210, excluding both end portions 210a and 210b of the main body 210 in the arrow-B direction. Furthermore, the main body 210 has the metal plating layer 230 over the entire surface of the concave groove 211. Moreover, the main body 210 has, at each of both end portions 211a and 211b of the concave groove 211 in the arrow-B direction, a wave receiving passageway 212 that penetrates the main body 210 in an arrow-C direction that is a direction intersecting the arrow-B direction and has the metal plating layer 230 over the entire surface. It is to be noted that the concave groove 211 and the wave receiving passageway 212 may be formed by molding, or may be formed by, for example, other modifications such as machining.

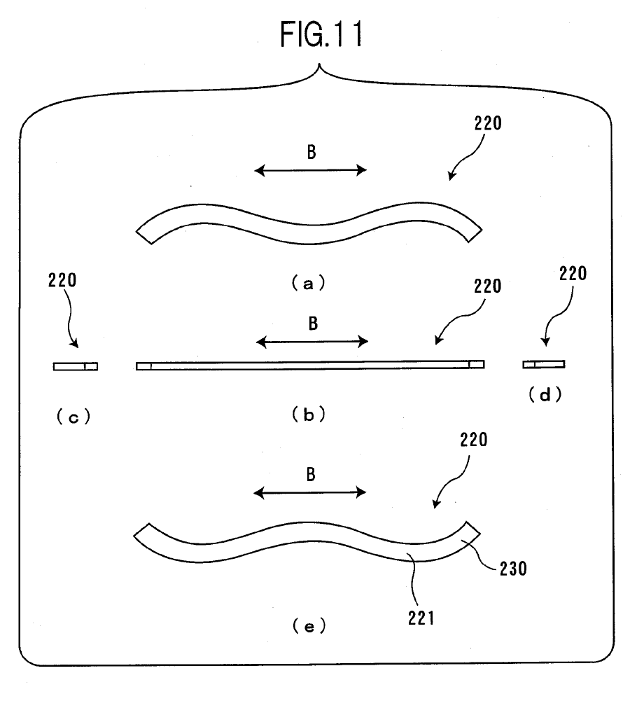

Similarly to the main body 210, the inner housing 220 shown in FIG. 7, FIG. 9 and FIG. 11 is formed by molding an ABS resin. Further, the inner housing 220 has a flat shape with a width equal to a width of the main body 210, and covers the entire concave groove 211 of the main body 210. Furthermore, the inner housing 220 has the metal plating layer 230 over an entire face 221 including a part of an inner wall that defines a wave receiving transmission path (a transmission path) formed by covering the concave groove 211 of the main body 210 with the inner housing 220 and applying ultrasonic welding or heat welding thereto.

As shown in FIG. 8 and FIG. 9, the metal plating layer 230 in the embodiment shown has a three-layer structure which protects against corrosion. Specifically, the metal plating layer 230 has a copper plating layer 231 that adheres to the ABS resin forming each of the main body 210 and the inner housing 220, a nickel plating layer 232 that adheres to and laminated on this copper plating layer 231, and a gold plating layer 233 that adheres to and laminated on the nickel plating layer 232. Further, surfaces of each of the concave groove 211 and the wave receiving passageway 212 of the main body 210 as well as the face 221 of the inner housing 220, each of which includes areas that adhere with the metal plating layer 230 (this area will be hereinafter referred to as a plating area), are roughened to increase an adherence to the plating. Thus, the metal plating layer 230, which is formed by plating the surface of the ABS resin forming each of the main body 210 and the inner housing 220 with metal after selectively roughening the surfaces, is obtained by masking an area of the surface of the ABS resin excluding the above-described plating area, in a roughening process and a plating process.

What is formed by covering the concave groove 211 of the main body 210 with the inner housing 220 and applying ultrasonic welding or heat welding thereto is the waveguide 200 according to the invention, and the wave receiving transmission path formed thereby becomes the transmission path. Further, the concave groove 211 of the main body 210 is formed inside both end portions 210a and 210b of the main body 210 and furthermore, the wave receiving passageway 212 is provided in each of the both end portions 211a and 211b of the concave groove 211, and the inner housing 220 covers the entire concave groove 211 and thereby, the waveguide 200 has transmission path shaped like a letter U in a manner similar to the waveguide 100 of the aforementioned embodiment. Moreover, similar to the waveguide 100, the cross section of this transmission path is rectangular, and the waveguide 200 is a waveguide for millimeter waves used for the millimeter wave communication of 60 GHz and thus, the section size of this transmission path is, for example, “0.4 mm×0.4 mm.” It is to be noted that the section size of the transmission path may be larger than, or may be smaller than “0.4 mm×0.4 mm.”

It is to be noted that the waveguide 200 has been described by taking the example in which “each of the main body and the inner housing is made of one kind of resin having the metal plating layer selectively, and the selective metal plating layer is obtained by masking the area excluding the plating area in the roughening process and the plating process.” However, the way of implementing the selective metal plating layer on the waveguide having the one kind of resin is not limited to this. For example, it may be a way of implementing a selective metal plating layer, in which “each of a main body and an inner housing is made of one kind of resin with copper mixed, and the copper is separated from the resin by irradiating a selected area of the surface of this resin with an infrared laser and exposed at a laser irradiation point, and this is put in a copper plating bath, so that a copper plating layer is selectively formed.”

In this way, the waveguide 200 is configured of the main body 210 and the inner housing 220, and the transmission path is the wave receiving transmission path formed by covering the concave groove 211 of the main body 210 with the inner housing 220 having a flat shape. Thus, when the metal plating layer 230 is formed along each of the main body 210 and the inner housing 220, in a manner similar to that of the waveguide 100, and the main body 210 and the inner housing 220 are separate from each other, the metal plating layer 230 is exposed. Therefore, according to the waveguide 200 of the invention, similarly to the waveguide 100, it is possible to avoid a problem of clogging of the transmission path due to plating accumulation. Further, according to the waveguide 200 of the shown embodiment, it is possible to avoid a problem uneven plating. Moreover, according to the waveguide 200 of the sown embodiment, visual inspection of the metal plating layer 230 is easy and thus, a defect in the metal plating layer such as “plating missing” may be removed. As a result, the surface of the metal plating layer 230 may be made even.

Further, in the waveguide 200, the concave groove 211 is formed only in the main body 210, of the main body 210 and the inner housing 220 forming the waveguide 200, and the inner housing 220 has the flat shape and thus, production thereof is easier than that of the waveguide 100 of the first embodiment in which the concave groove is formed in each of both the main body and the inner housing.

This completes the description of another embodiment of the invention.

As described above, the waveguides 100 and 200 according to the invention provides a waveguide made of resin, which enables even metal plating to be formed irrespective of the length in the longitudinal length and the diameter of the transmission path, and makes inspection of the formed metal plating easy.

Further, the waveguide of the invention may support various shapes, such as a shape extending linearly in a longitudinal direction like waveguide 100 or a shape extending in a longitudinal direction while curving like waveguide 200.

It is to be noted that for each of the embodiments described above, the description has been provided by taking the example in which the waveguide of the invention is the millimeter-wave waveguide used for the millimeter wave communication of 60 GHz, but the waveguide of the invention is not limited to these, and may be, for example, a millimeter-wave waveguide used for microwave communication, or may be a millimeter-wave antenna.

Furthermore, for each of the embodiments described above, the description has been provided by taking the example in which the metal plating layer according to the invention has the two-layer structure or the three-layer structure, but the metal plating layer according to the invention is not limited to these, and may be a metal plating layer having at least one layer in a case where protection against corrosion is not considered.

Moreover, each of the main body 210 and the inner housing 220 of the waveguide 200 may be formed by two shot molding.

Also, for each of the embodiments described above, the description has been provided by taking the example in which the waveguide of the invention has the rectangular cross section, but the waveguide of the present invention is not limited to these, and may have, for example, a circular cross section.

Further, for each of the embodiments described above, the description has been provided by taking the example in which the wave receiving transmission path (transmission path) is defined by bonding the main body and the inner housing of the invention to each other or applying the ultrasonic welding or the heat welding thereto, but these are not limitations, and, for example, the wave receiving transmission path (transmission path) may be defined by fitting or the like.

Furthermore, for each of the embodiments described above, the description has been provided by taking the example in which each of the main body and the inner housing according to the invention is one piece in the longitudinal direction, but each of the main body and the inner housing according to the invention is not limited thereto and may be formed by integrating segments resulting from division in a longitudinal direction.

Although certain embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A waveguide comprising:
a main body having a resin body member, a concave groove extending in a longitudinal direction and a body metal plating layer over an entire surface of the concave groove;
an inner housing having a resin cover member and an inner housing metal plating layer along an inner wall of the inner housing; and
a wave transmission path formed by the inner housing and the concave groove.

2. The waveguide according to claim 1, wherein the resin body member is formed by two shot molding of a first resin forming an internal layer adhering to the body metal plating layer, and a second resin forming an external layer adhering to the first resin opposite the body metal plating layer.

3. The waveguide according to claim 2, wherein the inner housing has a flat shape and the inner housing metal plating layer covers an entire face of the inner wall.

4. The waveguide according to claim 3, wherein the concave groove is formed between end portions of the main body.

5. The waveguide according to claim 4, wherein the inner housing covers the concave groove between end portions of the main body.

6. The waveguide according to claim 5, wherein a thickness of the inner housing is smaller than a thickness of the main body.

7. The waveguide according to claim 6, wherein the main body includes a wave receiving passageway passing through the main body in a direction intersecting the longitudinal direction of the waveguide.

8. The waveguide according to claim 7, wherein the wave receiving passageway is positioned along each of the end portions.

9. The waveguide according to claim 8, wherein the wave receiving passageway includes a metal plating layer over an entire surface.

10. The waveguide according to claim 1, wherein the concave groove is formed between end portions of the main body.

11. The waveguide according to claim 10, wherein the inner housing covers the concave groove between end portions of the main body.

12. The waveguide according to claim 11, wherein a thickness of the inner housing is thinner than the end portions.

13. The waveguide according to claim 1, wherein the main body includes a wave receiving passageway passing through the main body in a direction intersecting a longitudinal direction of the waveguide.

14. The waveguide according to claim 13, wherein the wave receiving passageway is positioned along each of the end portions.

15. The waveguide according to claim 14, wherein the wave receiving passageway includes a metal plating layer over an entire surface.
